(19) United States
(12) Patent Application Publication
(10) Pub. No.: US 2025/0216709 A1
(43) Pub. Date: Jul. 3, 2025

(54) PIXEL GRAYSCALE MODULATION STRUCTURE BASED ON PHASE CHANGE MATERIALS

(71) Applicant: Huazhong University of Science and Technology, Wuhan (CN)

(72) Inventors: Hao TONG, Wuhan (CN); Qipei ZHOU, Wuhan (CN); Qingshan TAN, Wuhan (CN); Binhao WANG, Wuhan (CN); Zhang LE, Wuhan (CN); Xiangshui MIAO, Wuhan (CN)

(73) Assignee: Huazhong University of Science and Technology, Wuhan (CN)

(21) Appl. No.: 19/003,172

(22) Filed: Dec. 27, 2024

(30) Foreign Application Priority Data
Dec. 27, 2023 (CN) 202311827508.4

(51) Int. Cl. G02F 1/03

(52) U.S. Cl. CPC G02F 1/0311; G02F 1/0316

(57) ABSTRACT

The invention relates to a pixel grayscale modulation structure based on phase change materials, which has characteristics of a high grayscale level, a high light utilization rate, a fast response speed and a high resolution. It mainly includes n multi-layer phase change unit arrays in each sub-pixel, an upper all-dielectric filter structure, an all-dielectric intermediate cavity, a lower all-dielectric filter structure, a crossbar control structure, which is suitable for various display devices, including but not limited to electronic paper, projection devices, augmented reality/virtual reality equipment (AR/VR), vehicle display, mobile device display, and the like.

### CROSS-REFERENCE TO RELATED APPLICATIONS

The application claims priority to Chinese patent application No. 202311827508.4, filed on Dec. 27, 2023, the entire contents of which are incorporated herein by reference.

### TECHNICAL FIELD

The present invention relates to the technical field of phase change materials, and more specifically, to a pixel grayscale modulation structure based on phase change materials.

### BACKGROUND

Phase change materials (PCM) are a kind of materials with reversible phase change properties, which can achieve rapid photo response through electric field stimulation. Compared with traditional liquid crystal materials, phase change materials have a faster optical response speed (nanosecond level) and a smaller pixel size (nanometer level). Phase change display technology is a display technology that uses the photoelectric characteristics of phase change materials to control a color or a gray level of pixels. Phase change display technology has the characteristics of a high resolution, a high frame rate and a low energy consumption.

Although phase-change display technology can achieve high quality image display in theory, it is still a challenge to control the gray level of pixels in practical applications. This is mainly because in the general phase change display structure, each phase change unit can only be in two states-crystalline or amorphous, which means that each unit can only provide two levels of gray.

To achieve more gray levels, the traditional solution is to use multiple layers of phase change materials, in which each layer of phase change material can be individually switched states to provide more gray levels. However, with the superposition of the number of layers, each layer of phase change materials can still only be in two states, the total gray level of each pixel is still limited, and the superposition of multi-layer phase change materials reduces the transmittance of the backlight, thus increasing the energy consumption.

In order to solve the above problems, we propose a pixel grayscale modulation structure based on phase change materials, which can not only improve the transmission and image quality of pixels, but also simplify the manufacturing process and reduce the cost. Therefore, our solution provides a new phase change display technology with a high gray scale, a high transmittance and a low cost.

### SUMMARY

The present invention provides a pixel grayscale modulation structure based on phase change material, aiming at realizing a novel phase change display device with a high grayscale level, a high transmittance and a low cost.

The pixel grayscale modulation structure based on phase change materials mainly includes n multi-layer phase change unit arrays in each sub-pixel, an upper all-dielectric filter structure, an all-dielectric intermediate cavity, a lower all-dielectric filter structure and a crossbar control structure. A multi-layer phase change unit array is distributed in each sub-pixel, and there are n phase change regulatory units in each sub-pixel. By adjusting the number of phase changes in each sub-pixel, the luminous intensity of the sub-pixel is controlled, and a gray level of a pixel dot is further controlled. The upper all-dielectric light filter structure is composed of alternately high and low refractive index materials, which is used to enhance the structural transmittance and reduce the light transmission of non-target wavelength. The all-dielectric intermediate cavity is composed of an all-dielectric material with a high refractive index, and is used to improve the transmission characteristics of the filter structure and reduce a stray light. The lower all-dielectric filter structure is used to further enhance an overall transmittance and reduce an light transmission of non-target wavelengths.

The multi-layer phase change unit includes a plurality of phase change material layers (layer number≥2), and there is a common electrode between each phase change material layer, and a phase change state of each phase change material layer can independently be controlled by applying a voltage, so as to achieve a multi-gray control.

An arrangement mode of the phase change control unit array can be a square array arrangement, a strip arrangement, a hexagon or a honeycomb arrangement and other arrangements.

A structure of the upper all-dielectric filter structure and the lower all-dielectric filter structure is H (LH) x, where H is the film layer of high refractive index and low extinction coefficient, L is the film layer of low refractive index and low extinction coefficient, X is the number of periods of the film layer group (X≥1), and an optical thickness of each film layer is one quarter of a target light wavelength.

The all-dielectric intermediate cavity is composed of all-dielectric materials with a high refractive index, and the thickness is one half of the optical thickness of the transmitted light, so as to effectively improve the transmission characteristics of the filter structure.

The crossbar control structure includes a horizontal electrode layer composed of a plurality of horizontal electrodes and a horizontal electrode layer composed of a plurality of vertical electrodes, and the plurality of horizontal electrodes and the plurality of vertical electrodes form an array of crossing points, each of which has a light-modulated pixel unit in the middle.

This grayscale modulation structure is suitable for a variety of display devices, including but not limited to electronic paper, projection devices, augmented reality/virtual reality devices (AR/VR), vehicle displays, mobile device displays, and the like.

### BRIEF DESCRIPTION OF DRAWINGS

FIG. 1 is a diagram of an array and a strip distribution of the pixel grayscale modulation structure in pixels of the invention;

FIG. 2 is a structure diagram of the all-dielectric filter structure of the invention;

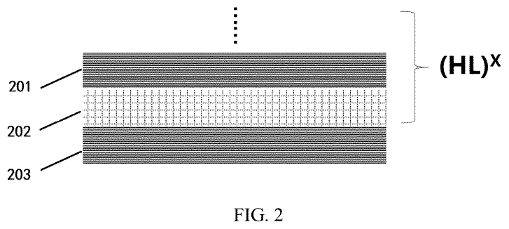

FIG. 3 is a structure diagram of the all-dielectric filter structure of the invention;

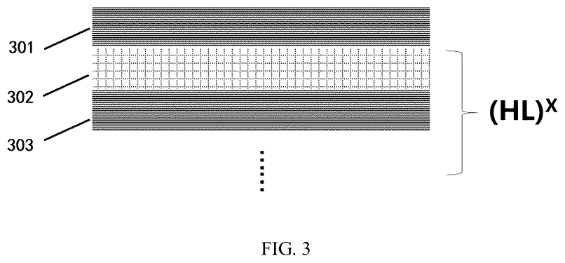

FIG. 4 is a structure diagram of the crossbar control electrode of the invention.

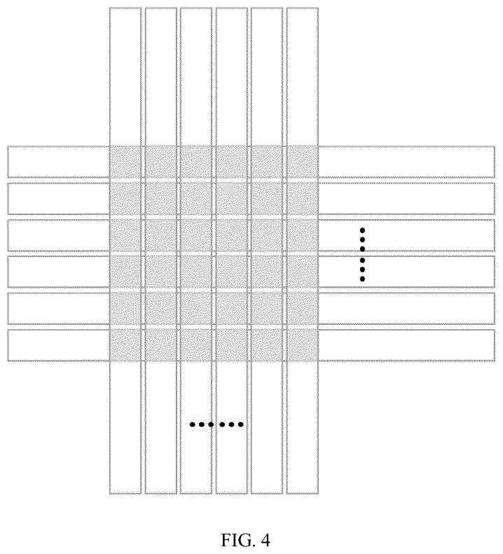

### NUMERALS IN THE DRAWINGS

101, 105, red sub-pixels; 102, 106, green sub-pixels; 103, 107, blue sub-pixels; 104, 108, phase change control unit; 201, 203, 301, 303, film layer of high refractive index and low extinction coefficient; 202, 302, film layer of low refractive index and low extinction coefficient.

### DETAILED DESCRIPTION OF THE EMBODIMENTS

In order to make the purpose, technical scheme and advantages of the invention more clearly understood, the invention is further explained combined with the drawings and embodiments in the following embodiment. It should be understood that the specific embodiments described herein are intended only to explain the invention and are not intended to qualify it. In addition, the technical features referred to in the various embodiments of the invention described below may be combined as long as they do not conflict with each other.

The invention provides a pixel grayscale modulation structure based on phase change materials, aiming at realizing a novel phase change display technology with a high grayscale level, a high transmittance and a low cost.

The pixel grayscale modulation structure provided by the invention comprises n multi-layer phase change unit arrays in each sub-pixel, an upper all-dielectric filter structure, an all-dielectric intermediate cavity, a lower all-dielectric filter structure and a crossbar control structure.

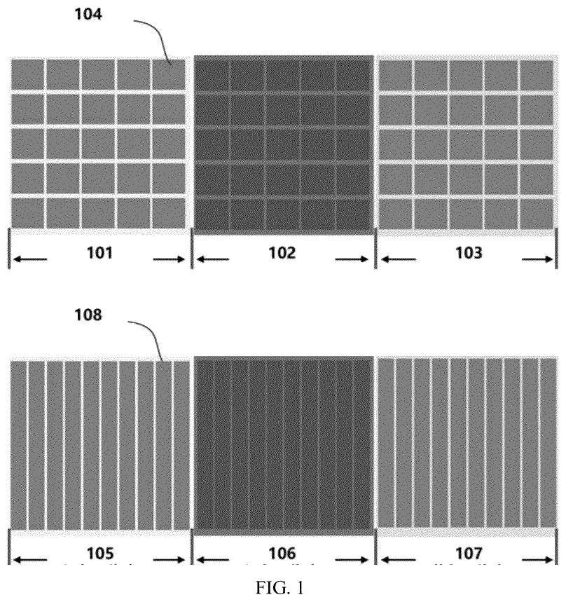

FIG. 1 shows an array and a strip distribution diagram of the pixel grayscale modulation structure in the pixels of the invention. Phase change unit arrays are distributed in each sub-pixel, and there are n phase change control units in each sub-pixel. By adjusting the number of phase changes in each sub-pixel, the luminous intensity of the sub-pixel is controlled and the gray level of the pixel is further controlled.

A structure of the upper all-dielectric filter structure and the lower all-dielectric filter structure is H (LH) x, where H is the film layer of high refractive index and low extinction coefficient, L is the film layer of low refractive index and low extinction coefficient, X is the number of periods of the film layer group (X≥1), and the optical thickness of each film layer is one-fourth of the wavelength used.

A role of the all-dielectric intermediate cavity is to solve a problem of weak transmitted light energy caused by interface reflection. The transmitted light processed by the intermediate cavity can not only improve the transmission rate, but also greatly reduce the energy of continuous light reflection between the elements, providing a high clarity. The materials of the all-dielectric intermediate cavity can include the following low-refractive index materials, including but not limited to: SiO2, Al2O3, In2O3, MgF2.

An arrangement of the crossbar control structure can be a square array arrangement, a strip arrangement, a hexagonal arrangement or a honeycomb arrangement. The crossbar control structure comprises a horizontal electrode layer composed of a plurality of horizontal electrodes and a vertical electrode layer composed of a plurality of vertical electrodes, and the plurality of horizontal electrodes and the plurality of vertical electrodes form a cross point array, each cross point in the middle has a light modulated pixel unit.

The phase change unit array includes a plurality of phase change material layers, the number of layers is ≥2, there is a common electrode between each phase change material layer, a phase state of each phase change material layer can be independently controlled by applying a voltage, so as to achieve a multi-gray control.

The phase change material of the phase change material layer can be transformed between the crystalline state and the amorphous state under electrical stimulation or laser stimulation, so that the transmittance of the phase change layer can be changed. Two transparent electrode layers of phase change materials sandwiched between the phase change layers can control the crystallization state of the phase change material by applying a voltage. Specifically, a pulse voltage or a laser pulse of medium intensity is applied to the phase change material layer. Under an action of a current or the laser pulse, a temperature of the phase change material rises to a temperature range above the crystallization temperature and below the melting temperature, and it is maintained for a certain time. At this time, the crystal lattice is arranged in order to form a crystal state, which realizes a transition from the amorphous state to the crystalline state. A short and strong voltage or a laser pulse is applied to the phase change material, so that the temperature of the phase change material rises above the melting temperature, so that a long range of the crystal state is orderly destroyed, and a pulse drop along a very short edge leads to a rapid cooling of the phase change material to below the crystallization temperature, so that the phase change material is fixed in the amorphous state, and the transformation from the crystalline state to the amorphous state is realized. A multi-color light emitted by multi-color quantum dot light emitting components is filtered by a change of the transmittance of the phase change material in the phase change material layer during a mutual transformation between the amorphous state and the crystalline state, so as to obtain the required wavelength and intensity of the monochromatic light, and then realize a color display.

The phase change material of the phase change material layer can be transformed between the crystalline state and the amorphous state under electrical stimulation or laser stimulation, so that the transmittance of the phase change layer can be changed. Two transparent electrode layers of phase change materials sandwiched between the phase change layers can control the crystallization state of the phase change material by applying a voltage. Specifically, a pulse voltage or a laser pulse of medium intensity is applied to the phase change material layer. Under an action of a current or the laser pulse, the temperature of the phase change material rises to a temperature range above the crystallization temperature and below the melting temperature, and it is maintained for a certain time. At this time, the crystal lattice is arranged in order to form a crystal state, which realizes the transition from the state amorphous to the crystalline state. A short but strong voltage or laser pulse is applied to the phase change material so that the phase change material of the phase change material layer may include the following chalcogenide compounds and their alloys, including but not limited to: GST, GSST, IST, GeTe, SbTe, BiTe, InSb, InSe, GeSb, SbSe, GaSb, GaSb, GeSbTe, AgInSbTe, InSbTe, Ag2In4Sb76Te17 (AIST). In addition, the percentages of atoms in each of the above chemical formulas are variable. The phase change material layer may further contain at least one dopant, such as C, N. Preferably, the phase change material Sb2Te3 is selected. Sb2Te3 has the largest change in transmittance before and after the phase change under the same thickness, and the phase change temperature of Sb2Te3 is low, the voltage or a laser amplitude required for the transformation is low, and the pulse width is narrow, which is convenient to reduce an energy consumption of the whole device and improve a response speed of the phase change material.

A thickness of the phase change material layer is less than 100 nm. Because a increase of the thickness of the phase change material layer will reduce the transmittance of visible light, and the temperature required for the crystallization of the phase change material is also higher, the more suitable thickness is 30 nm. The phase change material of the phase change material layer can be driven by a laser or a voltage. The transparent electrodes on both sides of the phase change layer apply voltage to the phase change material to enable the phase change of the phase change material.

The phase change layer of the phase change filter component has a large difference in transmittance in different states, and the phase change material is stable in the crystalline state and the amorphous state, so the phase change material can remove the voltage or the laser in the stable state, thus the power consumption of the entire display device in the display process is very low.

A speed of the phase change filter component is very fast when it is converted between the crystal state and the amorphous state, that is, the time required for a single pixel to turn from dark to bright or from light to dark is very short, about 100 ns below, which fully meets the requirements of various scenes.

Through the above examples, we can see that the pixel grayscale modulation structure based on phase change materials has characteristics of a fast response speed, a high resolution, a high gray level, a high light utilization rate, and can be used in a wide range of applications.

The grayscale modulation structure is suitable for a variety of display devices, including but not limited to electronic paper, projection devices, augmented reality/virtual reality devices (AR/VR), vehicle displays, mobile device displays, and the like.

It is easy for those skilled in the art to understand that the above is only a preferred embodiment of the invention and is not intended to limit the invention, and that any modification, equivalent replacement, improvement, and the like made within the spirit and principles of the invention shall be included in the scope of protection of the invention.

What is claimed is:

1. The pixel grayscale modulation structure based on phase change materials, is characterized by comprising n multi-layer phase change unit arrays in each sub-pixel, an upper all-dielectric filter structure, an all-dielectric intermediate cavity, a lower all-dielectric filter structure and a crossbar control structure;
wherein the multi-layer phase change unit array is distributed in each sub-pixel, and there are n phase change regulatory units in each sub-pixel; by regulating the number of phase change regulatory units in each sub-pixel, a luminous intensity of each sub-pixel is controlled, and then a gray level of the pixel is controlled;
the upper all-dielectric filter structure is composed of alternately high and low refractive index materials, which is used to enhance a structural transmittance and reduce a light transmission of a non-target wavelength;
the all-dielectric intermediate cavity is composed of all-dielectric materials with a high refractive index, and is used to improve transmission characteristics of the filter structure and reduce a stray light;
the lower all-dielectric filter structure is used to further enhance an overall transmittance and reduce the light transmission of the non-target wavelength.

2. The pixel grayscale modulation structure based on phase change materials according to claim 1, characterized in that the multi-layer phase change unit array comprises a plurality of phase change material layers, the number of layers is ≥2, there is a common electrode between each phase change material layer, a phase change state of each phase change material layer can be independently controlled by applying a voltage, so as to achieve a multi-gray level control.

3. The pixel grayscale modulation structure based on phase change materials according to claim 1, characterized in that an arrangement of the crossbar control structure can be a square arrangement, a strip arrangement, a hexagon or a honeycomb arrangement.

4. The pixel grayscale modulation structure based on phase change materials according to claim 1, characterized in that a structure of the upper all-dielectric filter structure and the lower all-dielectric filter structure is H (LH) x, where H is a film layer of high refractive index and low extinction coefficient, Lis a film layer of low refractive index and low extinction coefficient, X is the number of periods of the film layer group, X is ≥1, and an optical thickness of each film layer is one quarter of a target light wavelength.

5. The pixel grayscale modulation structure based on phase change materials according to claim 1, characterized in that the all-dielectric intermediate cavity is composed of an all-dielectric material with a high refractive index and a thickness is one half of an optical thickness of the transmitted light to effectively improve transmission characteristics of the filter structure.

6. The pixel grayscale modulation structure based on phase change materials according to claim 3, characterized in that the crossbar control structure comprises a horizontal electrode layer composed of a plurality of horizontal electrodes and a vertical electrode layer composed of a plurality of vertical electrodes, and the plurality of horizontal electrodes and the plurality of vertical electrodes form a cross point array, and each cross point in the middle has a light modulated pixel unit.

7. The pixel grayscale modulation structure based on phase change materials according to claim 1, characterized in that the pixel grayscale modulation structure is suitable for various display devices, including electronic paper, projection devices, augmented reality/virtual reality devices, vehicle displays, and mobile device displays.
